(19) United States
(12) Patent Application Publication
(10) Pub. No.: US 2026/0202589 A1
(43) Pub. Date: Jul. 16, 2026

(54) Fluid-Filled Tunable Lens with Actuators

(71) Applicant: Apple Inc., Cupertino, CA (US)

(72) Inventors: Oliver Hart, Cambridge (GB); Daniel J. Burbridge, Cambridge (GB); Richard J. Topliss, Cambridge (GB); Thomas M. Gregory, Cambridgeshire (GB); Roman Patscheider, Winterthur (CH); James E. Pedder, Oxon (GB)

(21) Appl. No.: 19/413,938

(22) Filed: Dec. 9, 2025

Related U.S. Application Data
(60) Provisional application No. 63/743,763, filed on Jan. 10, 2025.

(51) Int. Cl. G02B 3/14; G02B 7/02; G02B 27/01

(52) U.S. Cl. CPC G02B 3/14; G02B 7/026; G02B 27/0172

(57) ABSTRACT

A head-mounted device may have a lens module with a tunable lens. The tunable lens may include a fluid-filled chamber interposed between first and second lens elements. The tunable lens may include one or more actuators that control the shape of the first lens element. To mitigate the total actuation energy associated with the one or more actuators, the tunable lens may include bellows structures that are in tension for some or all of the displacement range of the lens shaping element, a pre-deformed lens shaping element, a magnetic negative stiffness element, a bistable springs negative stiffness mechanism, a cam roller negative stiffness mechanism, and/or a torsion spring.

### CROSS REFERENCE TO RELATED APPLICATIONS

This application claims the benefit of U.S. provisional patent application No. 63/743,763, filed January 10, 2025, which is hereby incorporated by reference herein in its entirety.

### BACKGROUND

This relates generally to electronic devices and, more particularly, to wearable electronic device systems.

Electronic devices are sometimes configured to be worn by users. For example, head-mounted devices are provided with head-mounted structures that allow the devices to be worn on users’ heads. The head-mounted devices may include optical systems with lenses. The lenses allow displays in the devices to present visual content to users.

Head-mounted devices typically include lenses with fixed shapes and properties. If care is not taken, it may be difficult to adjust these types of lenses to optimally present content to each user of the head-mounted device.

### SUMMARY

A tunable lens comprising a lens element having a periphery, a lens shaping element attached to the periphery of the lens element, actuators distributed around the periphery, each actuator being configured to adjust a position of the lens shaping element in a first direction within a displacement range, and a structure that is attached to the lens shaping element. The structure may include a sheet within a plane that is parallel to the first direction and the structure may be in tension when the lens shaping element is within at least some of the displacement range.

A tunable lens may include a first lens element having a periphery, a lens shaping element attached to the periphery of the first lens element, a second lens element, fluid interposed between the first and second lens elements, actuators distributed around the periphery, each actuator being configured to adjust a position of the lens shaping element in a first direction towards the second lens element, a first magnetic structure that is attached to the lens shaping element and that moves in parallel with the lens shaping element, and a second magnetic structure that is attracted to the first magnetic structure and that is adjacent to the second lens element.

A tunable lens may include a lens element having a periphery, a lens shaping element attached to the periphery of the lens element, actuators distributed around the periphery, each actuator being configured to adjust a position of the lens shaping element in a first direction within a displacement range, a bellows structure that is attached to the lens shaping element, and a fluid-filled chamber with walls that include at least the bellows structure and the lens element. The bellows structure may be in tension when the lens shaping element is within at least some of the displacement range.

### BRIEF DESCRIPTION OF THE DRAWINGS

FIG. 1 is a schematic diagram of an illustrative electronic device such as a head-mounted display device in accordance with some embodiments.

FIG. 2 is a top view of an illustrative head-mounted device in accordance with some embodiments.

FIG. 3 is a cross-sectional side view of an illustrative lens module with first and second lens elements in accordance with some embodiments.

FIGS. 4 and 5 are cross-sectional side views of an illustrative fluid-filled lens element in accordance with some embodiments.

FIG. 6 is a top view of an illustrative tunable lens with a lens shaping structure in accordance with some embodiments.

FIG. 7A is a simplified force diagram showing the forces acting upon the lens shaping element of FIGS. 4 and 5 when moved by an actuator in accordance with some embodiments.

FIG. 7B is a graph of force as a function of displacement for the tunable lens of FIGS. 4 and 5 in accordance with some embodiments.

FIG. 7C is a graph of force as a function of displacement for a tunable lens with a bellows structure under tension for some of the displacement range in accordance with some embodiments.

FIG. 7D is a cross-sectional side view of an illustrative tunable lens with a W-shaped bellows structure in accordance with some embodiments.

FIG. 8A is a simplified force diagram showing the forces acting upon a lens shaping element attached to a sheet bellows when moved by an actuator in accordance with some embodiments.

FIG. 8B is a graph of force as a function of displacement for a tunable lens with a sheet bellows in accordance with some embodiments.

FIG. 8C is a cross-sectional side view of an illustrative tunable lens with a sheet bellows structure in accordance with some embodiments.

FIG. 9A is a simplified force diagram showing the forces acting upon a lens shaping element attached to a magnetic structure when moved by an actuator in accordance with some embodiments.

FIG. 9B is a graph of force as a function of displacement for a tunable lens with magnetic structures in accordance with some embodiments.

FIG. 9C is a cross-sectional side view of an illustrative tunable lens with magnetic structures in accordance with some embodiments.

FIG. 9D is a cross-sectional side view of an illustrative lens shaping element with an embedded magnetic structure in accordance with some embodiments.

FIG. 9E is a cross-sectional side view of an illustrative chassis with an embedded magnetic structure in accordance with some embodiments.

FIG. 9F is a cross-sectional side view of an illustrative tunable lens with magnetic structures and a mechanism to apply force from the magnetic structures to a lens shaping element in accordance with some embodiments.

FIGS. 9G and 9H are cross-sectional side views of illustrative lens shaping elements attached to soft magnetic material in accordance with some embodiments.

FIG. 10A is a cross-sectional side view of an illustrative lens shaping element attached to bistable springs in accordance with some embodiments.

FIG. 10B is a cross-sectional side view of an illustrative lens shaping element attached to a cam roller mechanism in accordance with some embodiments.

FIG. 11A is a simplified force diagram showing the forces acting upon a lens shaping element attached to a torsion spring when moved by an actuator in accordance with some embodiments.

FIG. 11B is a graph of force as a function of displacement for a tunable lens with a torsion spring in accordance with some embodiments.

FIG. 11C is a cross-sectional side view of an illustrative tunable lens with a torsion spring in accordance with some embodiments.

FIG. 11D is a top view of an illustrative tunable lens with a torsion spring in accordance with some embodiments.

FIG. 11E is a cross-sectional side view of an illustrative actuator with an integral torsion spring in accordance with some embodiments.

FIG. 11F is a cross-sectional side view of the illustrative actuator of FIG. 11E after the actuator has been moved in accordance with some embodiments.

### DETAILED DESCRIPTION

Electronic devices may include displays and other components for presenting content to users. The electronic devices may be wearable electronic devices. A wearable electronic device such as a head-mounted device may have head-mounted support structures that allow the head-mounted device to be worn on a user’s head.

A head-mounted device may contain a display formed from one or more display panels (displays) for displaying visual content to a user. A lens system may be used to allow the user to focus on the display and view the visual content. The lens system may have a left lens module that is aligned with a user’s left eye and a right lens module that is aligned with a user’s right eye.

In some cases, the user may wish to view real-world content rather than a display. The user may require different optical prescriptions depending on the distance to an object, the degree to which the user’s eyes are verging (which may be predictable based on the distance to the object viewed), lighting conditions, and/or other factors. The head-mounted device may contain lenses disposed in such a way as the real-world content is viewable through the lens system.

The lens modules in the head-mounted device may include lenses that are adjustable. For example, fluid-filled adjustable lenses may be adjusted for specific viewers.

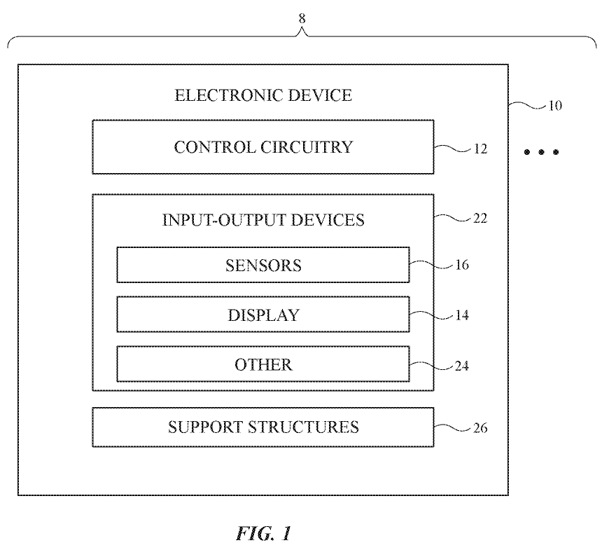

A schematic diagram of an illustrative system having an electronic device with a lens module is shown in FIG. 1. As shown in FIG. 1, system 8 may include one or more electronic devices such as electronic device 10. The electronic devices of system 8 may include computers, cellular telephones, head-mounted devices, wristwatch devices, and other electronic devices. Configurations in which electronic device 10 is a head-mounted device are sometimes described herein as an example.

As shown in FIG. 1, electronic devices such as electronic device 10 may have control circuitry 12. Control circuitry 12 may include storage and processing circuitry for controlling the operation of device 10. Circuitry 12 may include storage such as hard disk drive storage, nonvolatile memory (e.g., electrically-programmable-read-only memory configured to form a solid-state drive), volatile memory (e.g., static or dynamic random-access-memory), etc. Processing circuitry in control circuitry 12 may be based on one or more microprocessors, microcontrollers, digital signal processors, baseband processors, power management units, audio chips, graphics processing units, application specific integrated circuits, and other integrated circuits. Software code may be stored on storage in circuitry 12 and run on processing circuitry in circuitry 12 to implement control operations for device 10 (e.g., data gathering operations, operations involved in processing three-dimensional facial image data, operations involving the adjustment of components using control signals, etc.). Control circuitry 12 may include wired and wireless communications circuitry. For example, control circuitry 12 may include radio-frequency transceiver circuitry such as cellular telephone transceiver circuitry, wireless local area network (WiFi®) transceiver circuitry, millimeter wave transceiver circuitry, and/or other wireless communications circuitry.

During operation, the communications circuitry of the devices in system 8 (e.g., the communications circuitry of control circuitry 12 of device 10), may be used to support communication between the electronic devices. For example, one electronic device may transmit video and/or audio data to another electronic device in system 8. Electronic devices in system 8 may use wired and/or wireless communications circuitry to communicate through one or more communications networks (e.g., the internet, local area networks, etc.). The communications circuitry may be used to allow data to be received by device 10 from external equipment (e.g., a tethered computer, a portable device such as a handheld device or laptop computer, online computing equipment such as a remote server or other remote computing equipment, or other electrical equipment) and/or to provide data to external equipment.

Device 10 may include input-output devices 22. Input-output devices 22 may be used to allow a user to provide device 10 with user input. Input-output devices 22 may also be used to gather information on the environment in which device 10 is operating. Output components in devices 22 may allow device 10 to provide a user with output and may be used to communicate with external electrical equipment.

As shown in FIG. 1, input-output devices 22 may include one or more displays such as display 14. Display 14 may be used to display images for a user of head-mounted device 10. Display 14 may be a transparent or translucent display so that a user may observe physical objects through the display while computer-generated content is overlaid on top of the physical objects by presenting computer-generated images on the display. A transparent or translucent display may be formed from a transparent or translucent pixel array (e.g., a transparent organic light-emitting diode display panel) or may be formed by a display device that provides images to a user through a transparent structure such as a beam splitter, holographic coupler, or other optical coupler (e.g., a display device such as a liquid crystal on silicon display). Alternatively, display 14 may be an opaque display that blocks light from physical objects when a user operates head-mounted device 10. In this type of arrangement, a pass-through camera may be used to display physical objects to the user. The pass-through camera may capture images of the physical environment and the physical environment images may be displayed on the display for viewing by the user. Additional computer-generated content (e.g., text, game-content, other visual content, etc.) may optionally be overlaid over the physical environment images to provide an extended reality environment for the user. When display 14 is opaque, the display may also optionally display entirely computer-generated content (e.g., without displaying images of the physical environment).

Display 14 may include one or more optical systems (e.g., lenses) (sometimes referred to as optical assemblies) that allow a viewer to view images on display(s) 14. A single display 14 may produce images for both eyes or a pair of displays 14 may be used to display images. In configurations with multiple displays (e.g., left and right eye displays), the focal length and positions of the lenses may be selected so that any gap present between the displays will not be visible to a user (e.g., so that the images of the left and right displays overlap or merge seamlessly). Display modules (sometimes referred to as display assemblies) that generate different images for the left and right eyes of the user may be referred to as stereoscopic displays. The stereoscopic displays may be capable of presenting two-dimensional content (e.g., a user notification with text) and three-dimensional content (e.g., a simulation of a physical object such as a cube).

The example of device 10 including a display is merely illustrative and display(s) 14 may be omitted from device 10 if desired. Device 10 may include an optical pass-through area where real-world content is viewable to the user either directly or through a tunable lens.

Displays in device 10 such as display 14 may be organic light-emitting diode displays or other displays based on arrays of light-emitting diodes, liquid crystal displays, liquid-crystal-on-silicon displays, projectors or displays based on projecting light beams on a surface directly or indirectly through specialized optics (e.g., digital micromirror devices), electrophoretic displays, plasma displays, electrowetting displays, or any other suitable displays.

Input-output circuitry 22 may include sensors 16. Sensors 16 may include, for example, three-dimensional sensors (e.g., three-dimensional image sensors such as structured light sensors that emit beams of light and that use two-dimensional digital image sensors to gather image data for three-dimensional images from light spots that are produced when a target is illuminated by the beams of light, binocular three-dimensional image sensors that gather three-dimensional images using two or more cameras in a binocular imaging arrangement, three-dimensional lidar (light detection and ranging) sensors, three-dimensional radio-frequency sensors, or other sensors that gather three-dimensional image data), cameras (e.g., infrared and/or visible digital image sensors), gaze tracking sensors (e.g., a gaze tracking system based on an image sensor and, if desired, a light source that emits one or more beams of light that are tracked using the image sensor after reflecting from a user’s eyes), touch sensors, buttons, force sensors, sensors such as contact sensors based on switches, gas sensors, pressure sensors, moisture sensors, magnetic sensors, audio sensors (microphones), ambient light sensors, microphones for gathering voice commands and other audio input, sensors that are configured to gather information on motion, position, and/or orientation (e.g., accelerometers, gyroscopes, compasses, and/or inertial measurement units that include all of these sensors or a subset of one or two of these sensors), fingerprint sensors and other biometric sensors, optical position sensors (optical encoders), and/or other position sensors such as linear position sensors, and/or other sensors. Sensors 16 may include proximity sensors (e.g., capacitive proximity sensors, light-based (optical) proximity sensors, ultrasonic proximity sensors, and/or other proximity sensors). Proximity sensors may, for example, be used to sense relative positions between a user’s nose and lens modules in device 10.

User input and other information may be gathered using sensors and other input devices in input-output devices 22. If desired, input-output devices 22 may include other devices 24 such as haptic output devices (e.g., vibrating components), light-emitting diodes and other light sources, speakers such as ear speakers for producing audio output, and other electrical components. Device 10 may include circuits for receiving wireless power, circuits for transmitting power wirelessly to other devices, batteries and other energy storage devices (e.g., capacitors), joysticks, buttons, and/or other components.

Electronic device 10 may have housing structures (e.g., housing walls, straps, etc.), as shown by illustrative support structures 26 of FIG. 1. In configurations in which electronic device 10 is a head-mounted device (e.g., a pair of glasses, goggles, a helmet, a hat, etc.), support structures 26 may include head-mounted support structures (e.g., a helmet housing, head straps, temples in a pair of eyeglasses, goggle housing structures, and/or other head-mounted structures). The head-mounted support structures may be configured to be worn on a head of a user during operation of device 10 and may support display(s) 14, sensors 16, other components 24, other input-output devices 22, and control circuitry 12.

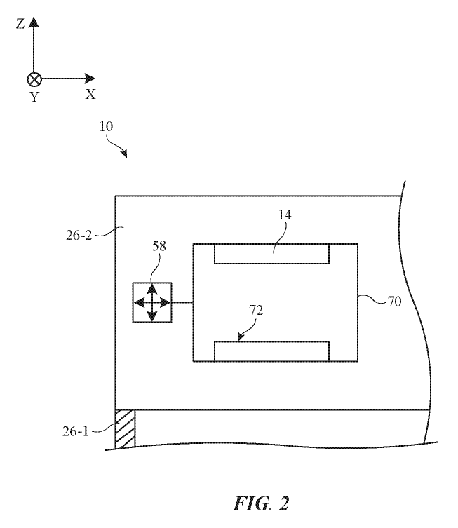

FIG. 2 is a top view of electronic device 10 in an illustrative configuration in which electronic device 10 is a head-mounted device. As shown in FIG. 2, electronic device 10 may include support structures (see, e.g., support structures 26 of FIG. 1) that are used in housing the components of device 10 and mounting device 10 onto a user’s head. These support structures may include, for example, structures that form housing walls and other structures for main unit 26-2 (e.g., exterior housing walls, lens module structures, etc.) and straps or other supplemental support structures such as structures 26-1 that help to hold main unit 26-2 on a user’s face.

The electronic device may include optical modules such as optical module 70. The electronic device may include left and right optical modules that correspond respectively to a user’s left eye and right eye. An optical module corresponding to the user’s left eye is shown in FIG. 2.

Each optical module 70 includes a corresponding lens module 72 (sometimes referred to as lens stack-up 72, lens 72, or adjustable lens 72). Lens 72 may include one or more lens elements arranged along a common axis. Each lens element may have any desired shape and may be formed from any desired material (e.g., with any desired refractive index). The lens elements may have unique shapes and refractive indices that, in combination, focus light (e.g., from a display or from the physical environment) in a desired manner. Each lens element of lens module 72 may be formed from any desired material (e.g., glass, a polymer material such as polycarbonate or acrylic, a crystal such as sapphire, etc.).

Modules 70 may optionally be individually positioned relative to the user’s eyes and relative to some of the housing wall structures of main unit 26-2 using positioning circuitry such as positioner 58. Positioner 58 may include stepper motors, piezoelectric actuators, motors, linear electromagnetic actuators, shape memory alloys (SMAs), and/or other electronic components for adjusting the position of displays, the optical modules 70, and/or lens modules 72. Positioners 58 may be controlled by control circuitry 12 during operation of device 10. For example, positioners 58 may be used to adjust the spacing between modules 70 (and therefore the lens-to-lens spacing between the left and right lenses of modules 70) to match the interpupillary distance IPD of a user’s eyes. In another example, the lens module may include an adjustable lens element. The curvature of the adjustable lens element may be adjusted in real time by positioner(s) 58 to compensate for a user’s eyesight and/or viewing conditions.

Each optical module may optionally include a display such as display 14 in FIG. 2. As previously mentioned, the displays may be omitted from device 10 if desired. In this type of arrangement, the device may still include one or more lens modules 72 (e.g., through which the user views the real world). In this type of arrangement, real-world content may be selectively focused for a user.

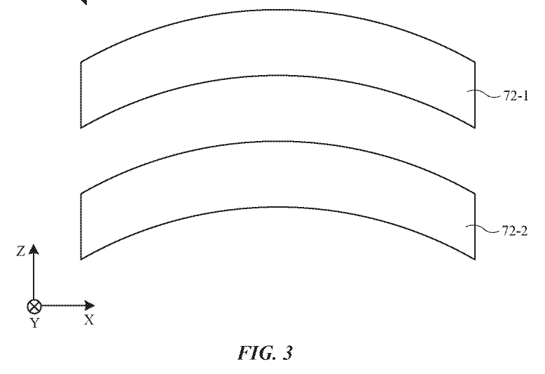

FIG. 3 is a cross-sectional side view of an illustrative lens module with multiple lens elements. As shown, lens module 72 includes a first lens element 72-1 and a second lens element 72-2. Each surface of the lens elements may have any desired curvature. For example, each surface may be a convex surface (e.g., a spherically convex surface, a cylindrically convex surface, or an aspherically convex surface), a concave surface (e.g., a spherically concave surface, a cylindrically concave surface, or an aspherically concave surface), or a freeform surface. A spherically curved surface (e.g., a spherically convex or spherically concave surface) may have a constant radius of curvature across the surface. In contrast, an aspherically curved surface (e.g., an aspheric concave surface or an aspheric convex surface) may have a varying radius of curvature across the surface. A cylindrical surface may only be curved about one axis instead of about multiple axes as with the spherical surface. In some cases, one of the lens surfaces may have an aspheric surface that changes from being convex (e.g., at the center) to concave (e.g., at the edges) at different positions on the surface. This type of surface may be referred to as an aspheric surface, a primarily convex (e.g., the majority of the surface is convex and/or the surface is convex at its center) aspheric surface, a freeform surface, and/or a primarily convex (e.g., the majority of the surface is convex and/or the surface is convex at its center) freeform surface. A freeform surface may include both convex and concave portions. Alternatively, a freeform surface may have varying convex curvatures or varying concave curvatures (e.g., different portions with different radii of curvature, portions with curvature in one direction and different portions with curvature in two directions, etc.). Herein, a freeform surface that is primarily convex (e.g., the majority of the surface is convex and/or the surface is convex at its center) may sometimes still be referred to as a convex surface and a freeform surface that is primarily concave (e.g., the majority of the surface is concave and/or the surface is concave at its center) may sometimes still be referred to as a concave surface. In one example, shown in FIG. 3, lens element 72-1 has a convex surface that faces display 14 and an opposing concave surface. Lens element 72-2 has a convex surface that faces lens element 72-1 and an opposing concave surface.

One or both of lens elements 72-1 and 72-2 may be adjustable. In one example, lens element 72-1 is a fixed (e.g., non-adjustable) lens element whereas lens element 72-2 is an adjustable lens element. The adjustable lens element 72-2 may be used to accommodate a user’s eyeglass prescription, for example. The shape of lens element 72-2 may be adjusted if a user’s eyeglass prescription changes (without needing to replace any of the other components within device 10). As another possible use case, a first user with a first eyeglass prescription (or no eyeglass prescription) may use device 10 with lens element 72-2 having a first shape and a second, different user with a second eyeglass prescription may use device 10 with lens element 72-2 having a second shape that is different than the first shape. Lens element 72-2 may have varying lens power and/or may provide varying amount of astigmatism correction to provide prescription correction for the user.

The example of lens module 72 including two lens elements is merely illustrative. In general, lens module 72 may include any desired number of lens elements (e.g., one, two, three, four, more than four, etc.). Any subset or all of the lens elements may optionally be adjustable. Any of the adjustable lens elements in the lens module may optionally be fluid-filled adjustable lenses. Lens module 72 may also include any desired additional optical layers (e.g., partially reflective mirrors that reflect 50% of incident light, linear polarizers, retarders such as quarter wave plates, reflective polarizers, circular polarizers, reflective circular polarizers, etc.) to manipulate light that passes through lens module.

As previously mentioned, one or more of the adjustable lens elements may be a fluid-filled lens element. An example is described herein where lens element 72-2 from FIG. 3 is a fluid-filled lens element. When lens element 72-2 is a fluid-filled lens element, the lens element may include one or more components that define the surfaces of lens element 72-2. These elements may also be referred to a lens element. In other words, adjustable lens element 72-2 (sometimes referred to as adjustable lens module 72-2) may be formed by multiple respective lens elements.

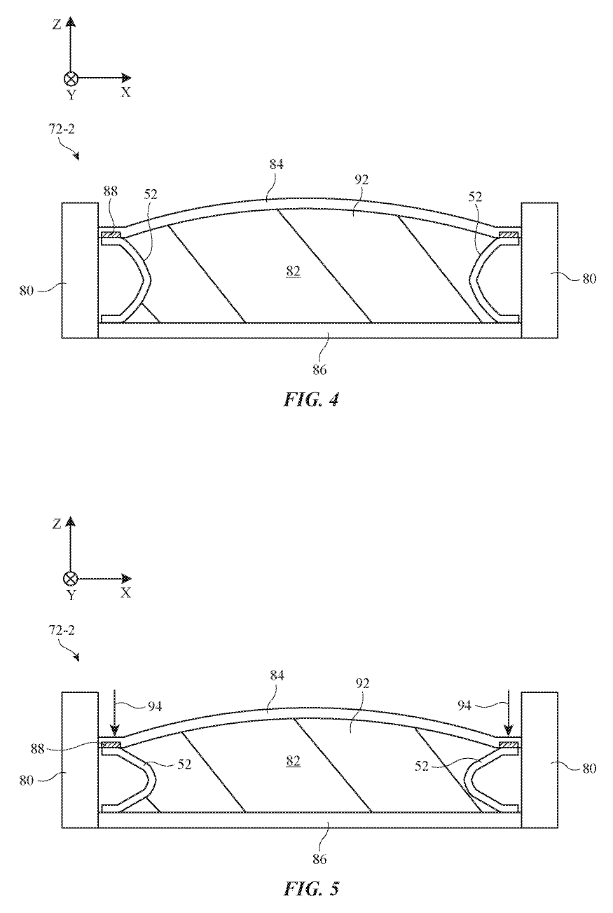

FIG. 4 is a cross-sectional side view of adjustable fluid-filled lens element 72-2. As shown, fluid-filled chamber 82 (sometimes referred to as chamber 82 or fluid chamber 82) that includes fluid 92 is interposed between lens elements 84 and 86. Fluid 92 may be a liquid, gel, or gas with a pre-determined index of refraction (and may therefore sometimes be referred to as liquid 92, gel 92, or gas 92). The fluid may sometimes be referred to as an index-matching oil, an optical oil, an optical fluid, an index-matching material, an index-matching liquid, etc. Lens elements 84 and 86 may have the same index of refraction or may have different indices of refraction. Fluid 92 that fills chamber 82 between lens elements 84 and 86 may have an index of refraction that is the same as the index of refraction of lens element 84 but different from the index of refraction of lens element 86, may have an index of refraction that is the same as the index of refraction of lens element 86 but different from the index of refraction of lens element 84, may have an index of refraction that is the same as the index of refraction of lens element 84 and lens element 86, or may have an index of refraction that is different from the index of refraction of lens element 84 and lens element 86. Lens elements 84 and 86 may have a circular footprint, may have an elliptical footprint, may have or may have a footprint of any another desired shape (e.g., an irregular footprint).

The amount of fluid 92 in chamber 82 may have a constant volume or an adjustable volume. If the amount of fluid is adjustable, the lens module may also include a fluid reservoir and a fluid controlling component (e.g., a pump, stepper motor, piezoelectric actuator, motor, linear electromagnetic actuator, and/or other electronic component that applies a force to the fluid in the fluid reservoir) for selectively transferring fluid between the fluid reservoir and the chamber.

Lens elements 84 and 86 may be transparent lens elements formed from any desired material (e.g., glass, a polymer material such as polycarbonate or acrylic, a crystal such as sapphire, etc.). Each one of lens elements 84 and 86 may be elastomeric, semi-rigid, or rigid. Elastomeric lens elements may be formed from a natural or synthetic polymer that has a low Young’s modulus for high flexibility. For example, the elastomeric membrane may be formed from a material having a Young’s modulus of less than 1 GPa, less than 0.5 GPa, less than 0.1 GPa, etc.

Semi-rigid lens elements may be formed from a semi-rigid material that is stiff and solid, but not inflexible. A semi-rigid lens element may, for example, be formed from a thin layer of polymer or glass. Semi-rigid lens elements may be formed from a material having a Young’s modulus that is greater than 1 Gpa, greater than 2 GPa, greater than 3 GPa, greater than 10 GPa, greater than 25 GPa, etc. Semi-rigid lens elements may be formed from polycarbonate, polyethylene terephthalate (PET), polymethylmethacrylate (PMMA), acrylic, glass, or any other desired material. The properties of semi-rigid lens elements may result in the lens element becoming rigid along a first axis when the lens element is curved along a second axis perpendicular to the first axis or, more generally, for the product of the curvature along its two principal axes of curvature to remain roughly constant as it flexes. This is in contrast to an elastomeric lens element, which remains flexible along a first axis even when the lens element is curved along a second axis perpendicular to the first axis. The properties of semi-rigid lens elements may allow the semi-rigid lens elements to form a cylindrical lens with tunable lens power and a tunable axis.

Rigid lens elements may be formed from glass, a polymer material such as polycarbonate or acrylic, a crystal such as sapphire, etc. In general, the rigid lens elements may not deform when pressure is applied to the lens elements within the lens module. In other words, the shape and position of the rigid lens elements may be fixed. Each surface of a rigid lens element may be planar, concave (e.g., spherically, aspherically, or cylindrically concave), or convex (e.g., spherically, aspherically, or cylindrically convex). Rigid lens elements may be formed from a material having a Young’s modulus that is greater than greater than 25 GPa, greater than 30 GPa, greater than 40 GPa, greater than 50 GPa, etc.

One or more structures such as bellows structure 52 (sometimes referred to as wall 52, flexible wall 52, flexible structure 52, etc.) and/or lens housing 80 (sometimes referred to as housing 80, lens chassis 80, chassis 80, support structure 80, etc.) may also define the fluid-filled chamber 82 of lens element 72-2. The bellows structure 52 is sufficiently compliant to permit adjustment to the shape of lens element 84. However, the bellows structure maintains a stable boundary for the fluid 92 inside fluid-filled chamber 82. Lens housing 80 may be a rigid housing structure and may serve as a mechanical ground for tunable lens 72-2.

In addition to lens elements 84 and 86 and fluid-filled chamber 82, lens module 72-2 also includes a lens shaping element 88. Lens shaping element 88 may be coupled to one or more actuators (e.g., positioned around the circumference of the lens module). The lens shaping element 88 may also be coupled to lens element 84. The actuators may be adjusted to position lens shaping element 88 (sometimes referred to as lens shaper 88, deformable lens shaper 88, lens shaping structure 88, lens shaping member 88, annular member 88, ring-shaped structure 88, etc.). The lens shaping element 88 in turn manipulates the positioning/shape of lens element 84. In this way, the curvature of the lens element 84 (and accordingly, the lens power of lens module 72-2) may be adjusted.

FIG. 5 is a cross-sectional side view of lens element 72-2 showing an illustrative adjustment of the shape of lens element 72-2. As shown, during adjustments of lens element 72-2, lens shaping element 88 (and correspondingly, lens element 84) may be biased in direction 94 at multiple points along its periphery (e.g., a point force is applied in direction 94 at multiple points). In this way, the curvature of the lens element 84 (and accordingly, the lens power of lens element 72-2) may be adjusted. In the example of FIG. 5, lens element 84 has more curvature than in FIG. 4.

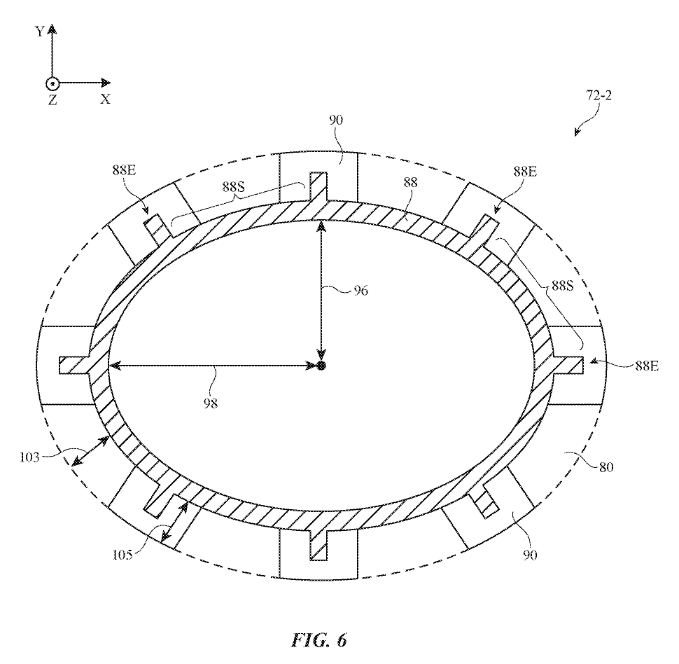

FIG. 6 is a top view of an illustrative lens shaping element 88. As shown, lens shaping element 88 may have an annular or ring shape with the lens shaping element surrounding a central opening. The lens shaping element may have any desired shape. For example, the lens shaping element may be circular, elliptical, or have an irregular shape. In the example of FIG. 6, the lens shaping element has an elliptical shape (e.g., a non-uniform radius around the ring shape). For example, a first distance 96 (e.g., a minimum distance) from the center of the central opening to the edge of the lens shaping element may be smaller than a second distance 98 (e.g., a maximum distance) from the center of the central opening to the edge of the lens shaping element. Distance 96 and 98 may be less than 100 millimeters, less than 60 millimeters, less than 40 millimeters, less than 30 millimeters, greater than 10 millimeters, greater than 20 millimeters, between 10 and 50 millimeters, etc.

Lens shaping element 88 may have a plurality of tabs 88E that extend from the main portion of the lens shaping element. The tabs 88E (sometimes referred to as extensions 88E, actuator points 88E, etc.) may each be coupled to a respective actuator 90 (sometimes referred to as actuation point 90). Each actuator may selectively move its respective extension 88E up and down (e.g., in the Z-direction) to control the position of tab 88E in the Z-direction. In other words, actuator 90 is a linear actuator.

FIG. 6 shows how a plurality of tabs 88E (and corresponding actuators) may be distributed around the perimeter of lens shaping element 88. Tabs 88E may be distributed around lens shaping element 88 in a uniform manner (e.g., with equal spacing between each pair of adjacent tabs 88E) or in a non-uniform manner (e.g., with unequal spacing between at least two of the adjacent tabs 88E).

Between each pair of adjacent tabs 88E, there is a lens shaper segment 88S. In the example of FIG. 6, there are 8 tabs 88E and 8 actuators 90 around the perimeter of lens shaping element 88. This example is merely illustrative. In general, more tabs (and corresponding actuators) allow for greater control of the shape of the lens element (e.g., lens element 84) to which lens shaping element 88 is coupled. Any desired number of tabs and actuators (e.g., one, two, three, four, more than four, more than six, more than eight, more than ten, more than twelve, more than twenty, less than twenty, less than ten, between four and twelve, etc.) may be used depending upon the specific target shapes for the lens element, the target cost/complexity of the lens module, etc.

Lens shaping element 88 may be elastomeric (e.g., a natural or synthetic polymer that has a low Young’s modulus for high flexibility, as discussed above in greater detail) or semi-rigid (e.g., formed from a semi-rigid material that is stiff and solid, but not inflexible, as discussed above in greater detail). A semi-rigid lens shaping element may, for example, be formed from a thin layer of polymer, glass, metal, etc. Because lens shaping element 88 is formed in a ring around the lens module, lens shaping element 88 does not need to be transparent (and therefore may be formed from an opaque material such as metal). The rigidity of lens shaping element 88 may be selected such that the lens shaping element assumes desired target shapes when manipulated by the actuators around its perimeter.

Actuators 90 may be positioned within lens housing 80. Lens housing 80 may optionally define a portion of the fluid-filled chamber 82. Lens housing 80 may have a width 103. Each actuator 90 may have a width 105. In some devices, it may be desirable for the magnitude of width 103 to be small (e.g., to achieve a thin bezel with a target aesthetic appearance). However, the magnitude of width 103 needs to be greater than or equal to the magnitude of width 105 (of actuators 90) to accommodate actuators 90. In other words, the width of the actuators may be a limiting factor in the width of the lens housing.

It may be desirable for the power consumption of actuators 90 to be mitigated. There may be a target range of displacement for lens shaping element 88 by each actuator 90. The magnitude of force required to displace the lens shaping element may increase with increasing magnitude of displacement. For example, a first amount of force is required to displace the lens shaping element by a first distance and a second amount of force that is greater than the first amount of force is required to displace the lens shaping element by a second distance that is greater than the first distance. The power consumption associated with the actuator displacing the lens shaping element may be proportional to the amount of force required to displace the lens shaping element. Continuing the example above, displacing the lens shaping element by the first distance may have a first amount of power consumption and displacing the lens shaping element by the second distance may have a second amount of power consumption that is greater than the first amount of power consumption.

To allow electronic device 10 to have a small form factor (e.g., with a small battery) and improve battery life, it may be desirable to mitigate the amount of power required to use actuators 90 to displace the lens shaping element across a target displacement range. To mitigate the power consumption of actuators 90, the stiffness of lens shaping element 88, lens element 84, and/or bellows structure 52 may be mitigated. However, there may be minimum required stiffnesses for these components to ensure satisfactory optical performance of the tunable lens.

Additional techniques to mitigate the amount of power required to use actuators 90 to displace the lens shaping element across a target displacement range include using molding bellows structures that are in tension for more of the displacement range of the lens shaping element, pre-deforming the lens shaping element to reduce the peak forces needed by the actuators, using a highly pre-strained membrane for the bellows structure, including a magnetic negative stiffness element in the tunable lens, including a bistable springs negative stiffness mechanism in the tunable lens, including a cam roller negative stiffness mechanism in the tunable lens, including a torsion spring to lower actuation force requirements, etc.

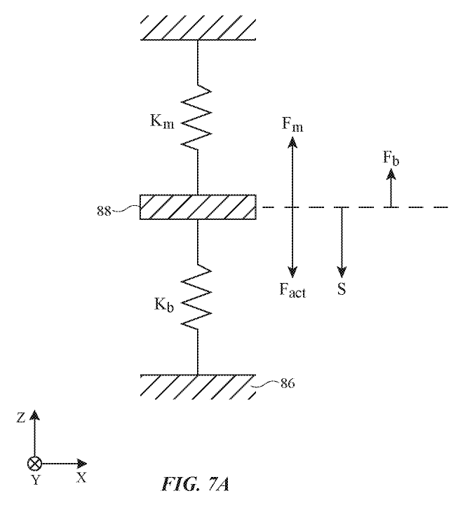

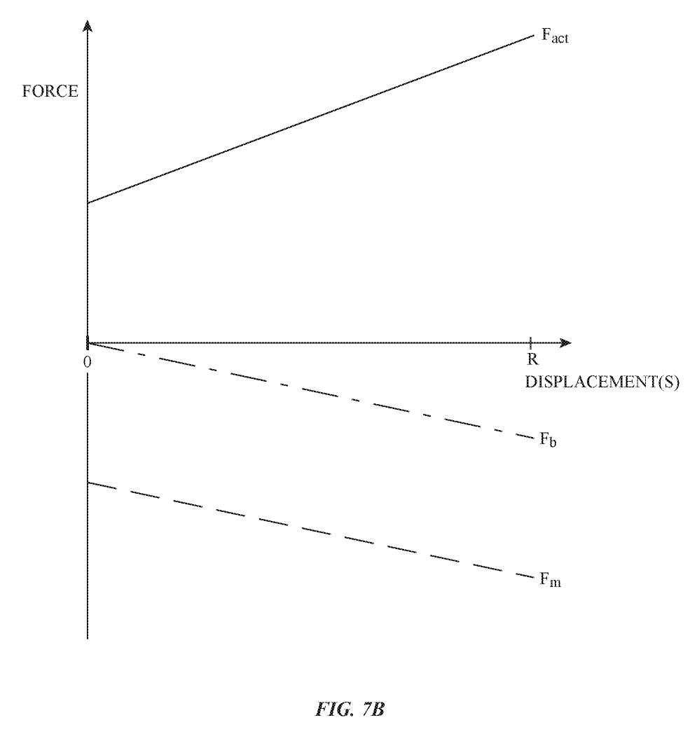

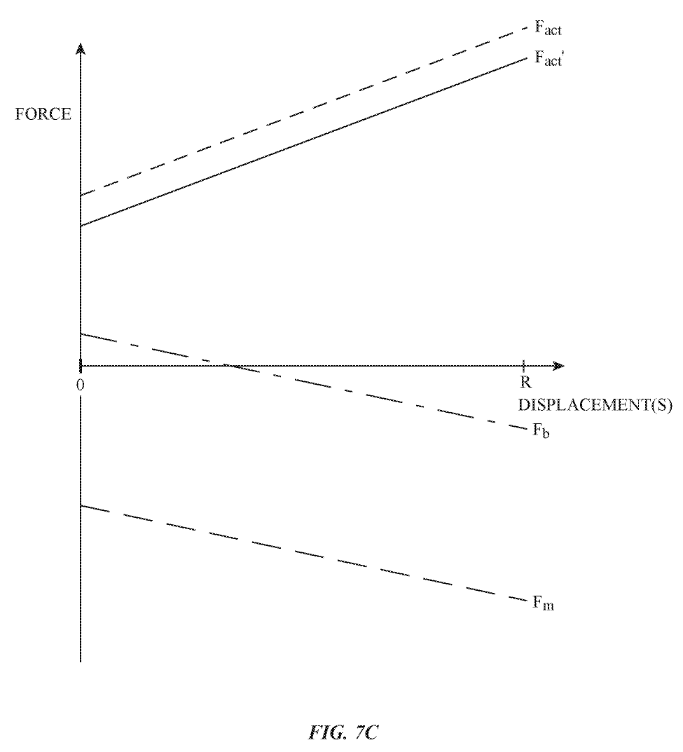

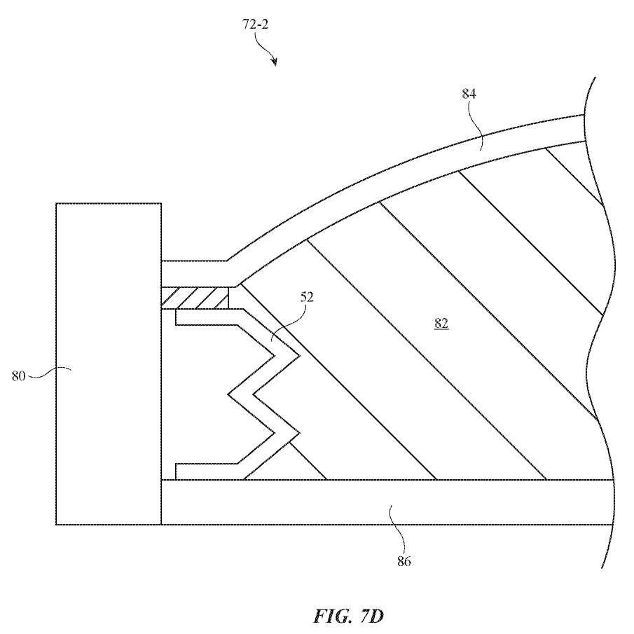

FIG. 7A is a simplified force diagram showing the forces acting upon lens shaping element 88 when moved by an actuator. FIG. 7A shows how a bellows structure with a stiffness K_{b} is interposed between the lens shaping element 88 and lens element 86 (or chassis 80 in some embodiments). The bellows structure imparts a force F_{b} upon the lens shaping element. Lens element 84 may be pre-strained before being attached to lens element 88, therefore causing a force Fₘ to be imparted on the lens shaping element by lens element 84. To displace lens shaping element 88 in a direction S (sometimes referred to as stroke), an actuation force F_{act} is required.

FIG. 7A shows the simplified force diagram for the tunable lens of FIGS. 4 and 5. With the tunable lens arrangement of FIGS. 4 and 5, the lens element 84 may be pre-strained such that Fₘ is applied in the positive Z-direction. Bellows structure 52 is compressed such that F_{b} is also applied in the positive Z-direction. Stroke S (and therefore the actuation force F_{act}) are applied in the negative Z-direction.

FIG. 7B is a graph of force as a function of displacement (e.g., stroke S from FIG. 7A) across a displacement range from 0 to R. In this graph, force in the negative Z-direction from FIG. 7A is defined as positive and force in the positive Z-direction from FIG. 7A is defined as negative. In the example of FIG. 7B, F_{b} is approximately 0 when the displacement is equal to 0. F_{b}then decreases with increasing displacement. Fₘ, meanwhile, starts at a negative value when displacement is equal to 0 and then decreases with increasing displacement. The actuation force F_{act} therefore has a positive value when displacement is equal to 0 and increases with increasing displacement. The total actuation energy required by the actuator for the tunable lens of FIGS. 4 and 5 may be equal to the integral of the F_{act} line in FIG. 7B.

To mitigate the total actuation energy required, a bellows structure may be used such that the bellows structure is in tension for more of the stroke of the actuator/lens shaping element. The graph of force as a function of displacement across the displacement range for a tunable lens with this modification is shown in FIG. 7C. In FIG. 7C, Fₘ is the same as in FIG. 7B. However, F_{b} has a positive value when displacement is 0 and remains positive over some of the displacement range. This indicates the bellows structure is in tension for some of the displacement range. F_{b} in FIG. 7C is uniformly shifted in the positive direction compared to FIG. 7B. FIG. 7C shows a profile for actuation force F_{act}’ associated with a tunable lens with the F_{b} and Fₘ magnitudes of FIG. 7C. The actuation force F_{act} from FIG. 7B is shown in FIG. 7C for comparison. As shown in FIG. 7C, actuation force F_{act}’ is less than F_{act} across the entire displacement range. The total actuation energy (associated with F_{act}’) is therefore lower in FIG. 7C than in FIG. 7B.

To summarize, using a bellows structure that is in tension for more of the displacement range (as in FIG. 7C) mitigates the total actuation energy required by the actuator. The bellows structure may have a C-shape (as in FIGS. 4 and 5) or a W-shape. FIG. 7D is a cross-sectional side view of an illustrative tunable lens with a W-shaped bellows structure 52. In contrast with the C-shaped bellows structure (which has one bend), the W-shaped bellows structure has three bends.

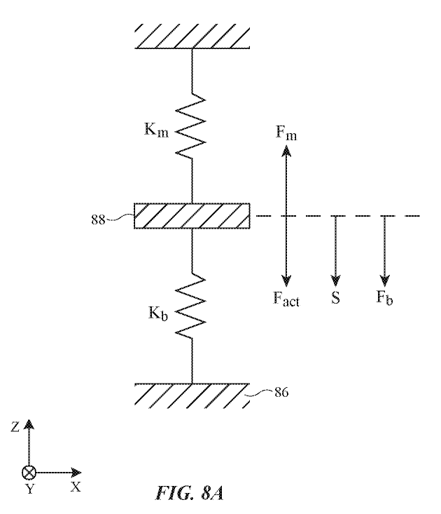

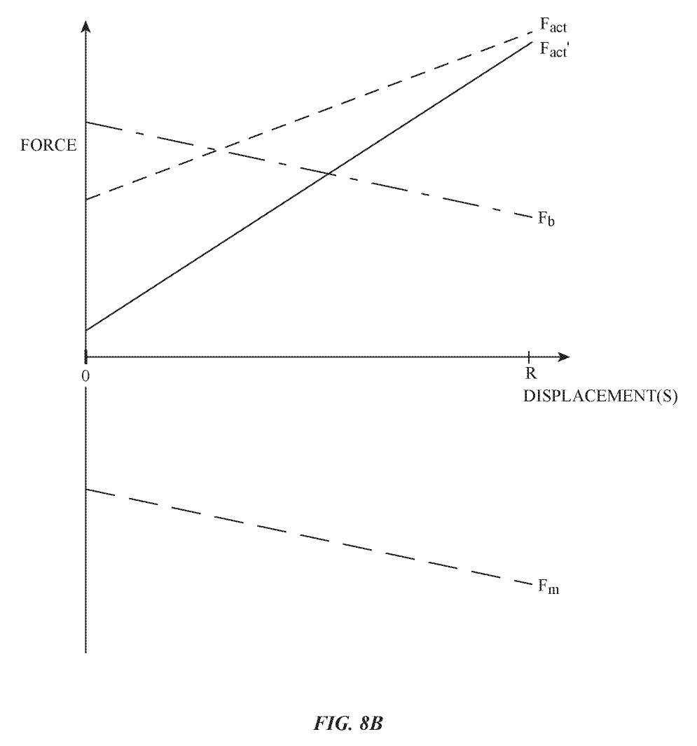

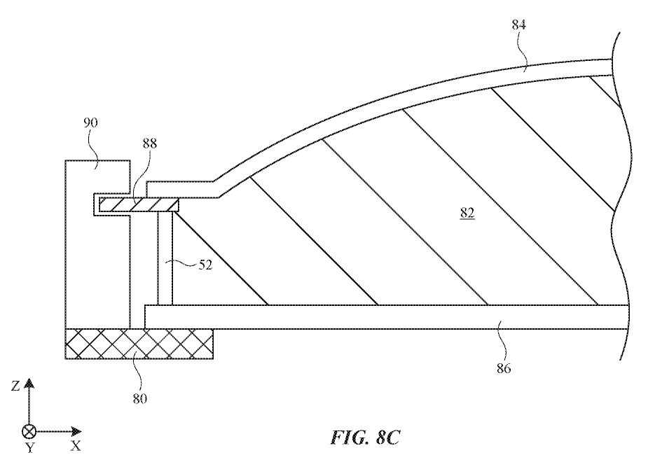

In another possible arrangement, the bellows structure may be highly pre-strained such that the bellows structure is in tension across the entire displacement range of the lens shaping element. As shown by the simplified force diagram of FIG. 8A, when the bellows structure is in tension across the entire displacement range the force F_{b} is in the negative Z-direction.

FIG. 8B is a graph of force as a function of displacement (e.g., stroke S from FIG. 8A) across a displacement range from 0 to R. The force Fₘ is the same in FIG. 8B as in FIG. 7B. However, the force F_{b} is positive across the entire range of displacement. FIG. 8B shows a profile for actuation force F_{act}’ associated with a tunable lens with the F_{b} and Fₘ magnitudes of FIG. 8B. The actuation force F_{act} from FIG. 7B is shown in FIG. 8B for comparison. As shown in FIG. 8B, actuation force F_{act}’ is less than F_{act} across the entire displacement range. The total actuation energy (associated with F_{act}’) is therefore lower in FIG. 8B than in FIG. 7B.

It is noted that, in FIG. 8B, actuation force F_{act}’ may not be less than F_{act} across the entire displacement range. The bellows structure of FIGS. 8A and 8B may have a higher stiffness than the bellows structure of FIGS. 7A and 7B. This may cause F_{act}’ to be greater than F_{act} at the upper end of the displacement range. However, the total actuation energy may still be lower in FIG. 8B than in FIG. 7B even when F_{act}’ is greater than F_{act} at the upper end of the displacement range.

FIG. 8C is a cross-sectional side view of a tunable lens with the highly pre-strained bellows structure of FIGS. 8A and 8B. As shown in FIG. 8C, bellows structure 52 (sometimes referred to as structure 52, wall 52, sidewall 52, sheet 52, etc.) may be a sheet that defines a plane that is parallel to the Z-axis. Instead of a plane, the sheet may have a curved cross-section (e.g., bulging in the negative X-direction in FIG. 8C), a conical shape tapering inwards or outwards in the positive Z-direction, etc. Bellows structure 52 may extend in the negative Z-direction away from the lens shaping element. The bellows structure of FIG. 8C may maintain a linear or near-linear cross-section throughout actuation (as opposed to folding like a W-shape bellows structure) and may therefore sometimes be referred to as a sheet bellows.

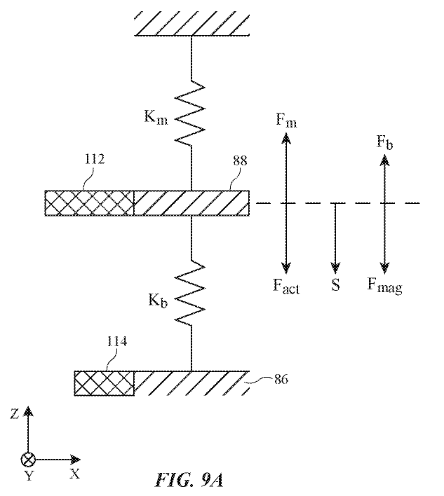

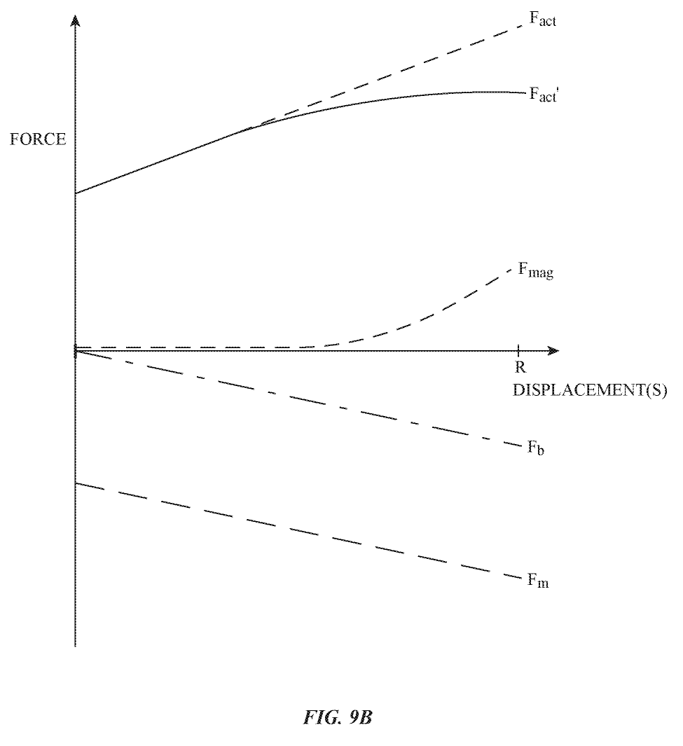

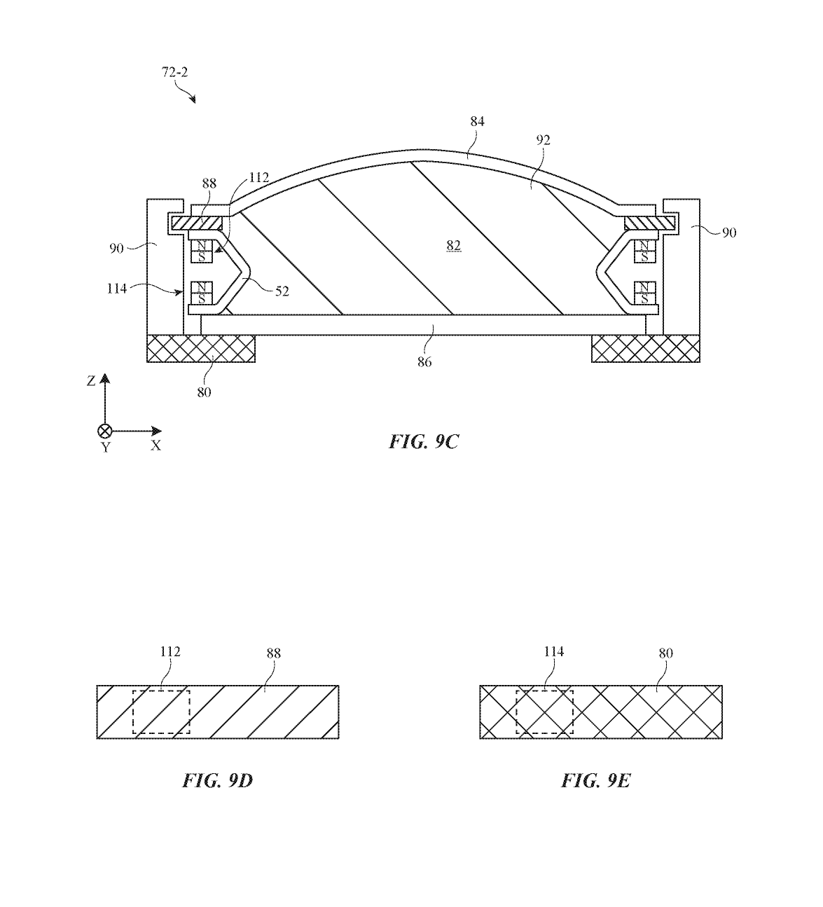

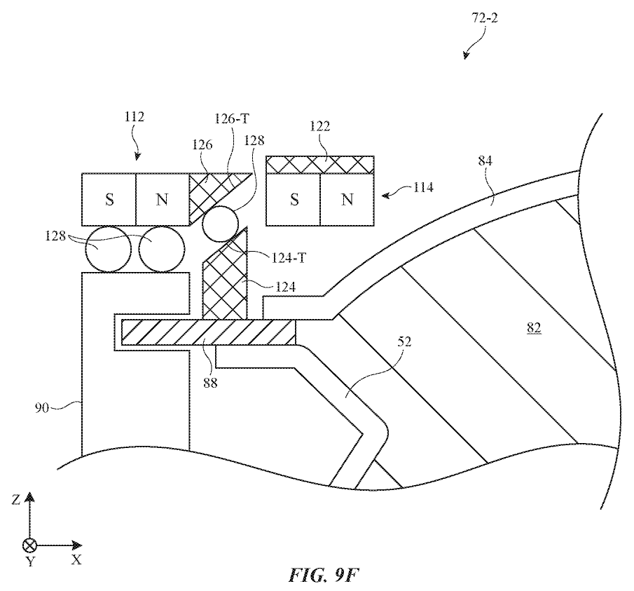

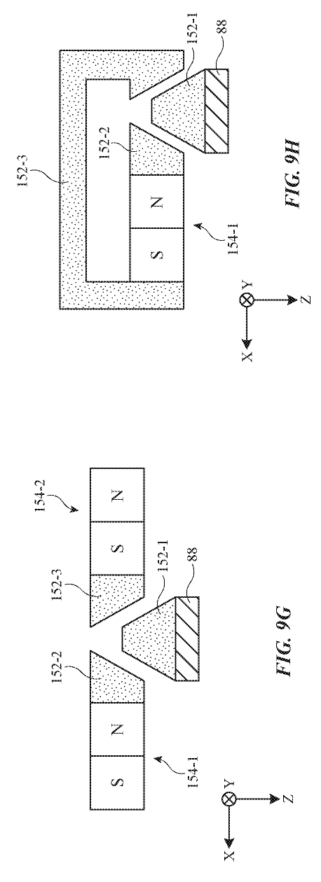

In another possible arrangement, shown in FIGS. 9A-9F, one or more magnetic structures may be used to mitigate total actuation energy for the actuators. FIG. 9A is a simplified force diagram of a tunable lens with one or more magnetic structures. In the example of FIG. 9A, a first magnetic structure 112 is attached to lens shaping element 88 and a second magnetic structure 114 is attached to lens element 86. The magnetic structures 112 and 114 may be attracted to each other and therefore create a force F_{mag} in the negative Z-direction on lens shaping element 88.

FIG. 9B is a graph of force as a function of displacement (e.g., stroke S from FIG. 9A) across a displacement range from 0 to R. The forces Fₘ and F_{b} are the same in FIG. 9B as in FIG. 7B. However, there is an additional force F_{mag} that may lower the total actuation energy. As shown in FIG. 9B, the magnitude of force F_{mag} may increase with increasing displacement. The magnitude of F_{mag} as a function of displacement may be non-linear, as shown in the example of FIG. 9B. In particular, the magnitude of F_{mag} may increase exponentially. When the displacement is low (and the magnetic structures are far apart) the magnetic attraction between the magnetic structures is relatively low. When the displacement is high (and the magnetic structures are close together) the magnetic attraction between the magnetic structures is relatively high.

FIG. 9B shows a profile for actuation force F_{act}’ associated with a tunable lens with the magnetic structures of FIG. 9A. The actuation force F_{act} from FIG. 7B is shown in FIG. 9B for comparison. As shown in FIG. 9B, actuation force F_{act}’ is less than F_{act} across the entire displacement range. The total actuation energy (associated with F_{act}’) is therefore lower in FIG. 9B than in FIG. 7B.

The magnetic structures 112 and 114 may comprise permanent magnets (e.g., formed from hard magnetic materials that retain their magnetism over time) and/or structures with high magnetic permeability.

FIG. 9C is a cross-sectional side view of an illustrative tunable lens with magnetic structures of the type shown in FIG. 9A. In the example of FIG. 9C, a first permanent magnet 112 is attached to an upper portion of bellows structure 52. The first permanent magnet is therefore attached to lens shaping element 88 via the bellows structure. A second permanent magnet 114 is attached to a lower portion of bellows structure 52. The second permanent magnet is therefore attached to chassis 80 via the bellows structure and lens element 86. The position of the second permanent magnet is therefore static (since it is attached to the static chassis 80) whereas the first permanent magnet is displaced along the Z-direction in parallel with the lens shaping element 88.

Each one of permanent magnets 112 and 114 may have a north pole (N) and an adjacent south pole (S). The designations of N (to represent north poles) and S (to represent south poles) in FIG. 9C and the other drawings is illustrative. It will be appreciated that throughout this description these designations can be reversed with no loss of generality (e.g., in any given embodiment S can be swapped for N and vice versa).

Each one of permanent magnets 112 and 114 may have a magnetic axis (sometimes referred to as magnetic pole axis) that is parallel to the Z-axis. The south pole of magnet 112 is adjacent to the north pole of magnet 114 such that magnets 112 and 114 are attracted together. In other words, each one of magnets 112 and 114 has its north pole positioned above its south pole in FIG. 9C.

If desired, one of magnetic structures 112 and 114 may be a structure (e.g., a piece of material) with high magnetic permeability instead of a permanent magnet. The structure with high magnetic permeability may comprise iron, steel, nickel, ferrite, zinc, etc. The structure with high magnetic permeability may have a relative permeability (the ratio of the material’s permeability to the permeability of free space) of at least 15, at least 40, at least 100, at least 1,000, at least 10,000, etc.

The positions of magnetic structures 112 and 114 in FIG. 9C are merely illustrative. Magnetic structure 112 may be positioned at any desired location within the tunable lens that moves in parallel with lens shaping element 88. Magnetic structure 114 may be positioned at any desired static location within the tunable lens (e.g., adjacent to lens element 86, adjacent to chassis 80, etc.). Magnetic structure 112 may be directly attached to lens shaping element 88 or lens element 84 instead of bellows structure 52. Magnetic structure 114 may be directly attached to lens element 86 or chassis 80 instead of bellows structure 52.

The magnetic structures may be attached to components within the tunable lens (e.g., using adhesive or another desired material) or may be embedded within components within the tunable lens. FIG. 9D shows an example of magnetic structure 112 embedded in lens shaping element 88. The magnetic structure 112 may be insert molded into the lens shaping element such that the lens shaping element surrounds and directly contacts the magnetic structure on all sides (or all but one or two sides). FIG. 9E shows an example of magnetic structure 114 embedded in chassis 80. The magnetic structure 114 may be insert molded into the chassis such that the chassis surrounds and directly contacts the magnetic structure on all sides (or all but one or two sides).

The example in FIG. 9C of magnetic structures 112 and 114 having magnetic axes parallel to the Z-axis is merely illustrative. In another possible arrangement, shown in FIG. 9F, magnetic structures 112 and 114 have magnetic axes orthogonal to the Z-axis. This may provide more flexibility for positioning of the magnetic structures within the tunable lens (e.g., allowing both magnetic structures 112 and 114 to be positioned above the lens shaping element as in FIG. 9F). The flexibility in positioning the magnetic structures may allow for the magnetic structures to be positioned closer together than in the example of FIG. 9C, which may be desirable in some designs.

When the magnetic structures 112 and 114 have magnetic axes orthogonal to the Z-axis (or another arrangement that does not directly cause the desired force on the lens shaping element in the negative Z-direction), a mechanism may be included to transfer the magnetic force to a force on the lens shaping element in the negative Z-direction. In FIG. 9F, structures 122, 124, and 126 and bearings 128 are included in tunable lens 72-2 to transfer the magnetic force between magnets 112 and 114 to a force on the lens shaping element in the negative Z-direction.

Magnet 114 is attached to structure 122. Structure 122 may be a static component connected to a mechanical ground (e.g., chassis 80) for tunable lens 72-2. Structure 124 may be attached directly to lens shaping element 88 and therefore moves in parallel with lens shaping element 88. Structure 124 has a tapered surface 124-T that presses against a bearing 128. Magnetic 112 is attached to structure 126. Structure 126 has a tapered surface 126-T that presses against a bearing 128. A bearing 128 is interposed between tapered surfaces 126-T and 124-T. There are also bearings between magnet 112 and another static structure within the tunable lens such as an upper surface of actuator 90.

Magnets 112 and 114 in FIG. 9F have magnetic axes parallel to the X-axis. The south pole of magnet 114 is adjacent to the north pole of magnet 112 such that magnets 112 and 114 are attracted together. In other words, each one of magnets 112 and 114 has its north pole positioned to the right of its south pole in FIG. 9F. As lens shaping element 88 is displaced in the negative Z-direction, magnet 112 may be displaced in the positive X-direction making magnets 112 and 114 closer together. The attraction between magnets 112 and 114 (in the X-direction) may apply a force to structure 124 (and lens shaping element 88) in the negative Z-direction.

In another possible arrangement, the lens shaping element may be attached to a soft magnetic material that causes displacement of the lens shaping element along the vertical direction when exposed to a magnetic field. FIG. 9G is a side view of an illustrative lens shaping element that is attached to a wedge-shaped soft magnetic structure 152-1. Permanent magnets 154-1 and 154-2 have magnetic axes orthogonal to the Z-axis. However, the presence of soft magnetic structures 152-1, 152-2, and 152-3, may cause the magnetic field generated by permanent magnets 154-1 and 154-2 to attract lens shaping element 88 in the negative Z-direction. The wedge-shaped magnetic structure 152-1 may have first and second tapered surfaces. The first tapered surface may abut a tapered surface of soft magnetic structure 152-2 that is attached to permanent magnet 154-1. The second tapered surface may abut a tapered surface of soft magnetic structure 152-3 that is attached to permanent magnet 154-2. The geometry of the tapered surfaces of structures 152 may be selected to adjust the force-displacement characteristics of the magnetic structures.

Soft magnetic materials refer to materials that are easily magnetized and demagnetized. Each soft magnetic structure 152 may comprise a soft magnetic material such as carbonyl iron, iron oxide, soft ferrite, an iron-silicon alloy, an iron-nickel alloy, etc.

FIG. 9H is a side view of an illustrative lens shaping element that is attached to a wedge-shaped soft magnetic structure 152-1, similar to as in FIG. 9G. In FIG. 9H, however, only one permanent magnet 154-1 is used to create the magnetic field that attracts lens shaping element 88 in the negative Z-direction. As shown in FIG. 9H, soft magnetic structure 152-2 with a tapered surface is attached to a first side of magnet 154-1. Soft magnetic structure 152-3 with a tapered surface is attached to a second, opposing side of magnet 154-1. The examples in FIGS. 9F-9H are merely illustrative. In general, the tunable lens may include any desired structures to transfer force from magnetic attraction between magnetic structures to the lens shaping element.

The magnetic structures in FIGS. 9A-9H may lower the effective system stiffness and therefore may be referred to as inverse stiffness components (or negative stiffness components). However, the example of using magnets as inverse stiffness components is merely illustrative and other inverse stiffness components may be used if desired.

Magnetic structures 112 and 114 (or 154-1 and 154-2 in FIGS. 9G and 9H) may be ring-shaped magnetic structures that extend around the entire circumference of the tunable lens. Alternatively, there may be multiple discrete magnetic structures 112 and 114. For example, each actuator 90 from FIG. 6 may have a respective magnetic structure 112 and a respective magnetic structure 114. When multiple discrete magnetic structures 112 and 114 are used, the properties of the magnetic structures may be different at each actuator. For example, the permanent magnet at a first actuator may be larger than the permanent magnet at a second actuator, the permanent magnet at a first actuator may comprise a different material than the permanent magnet at a second actuator, etc.

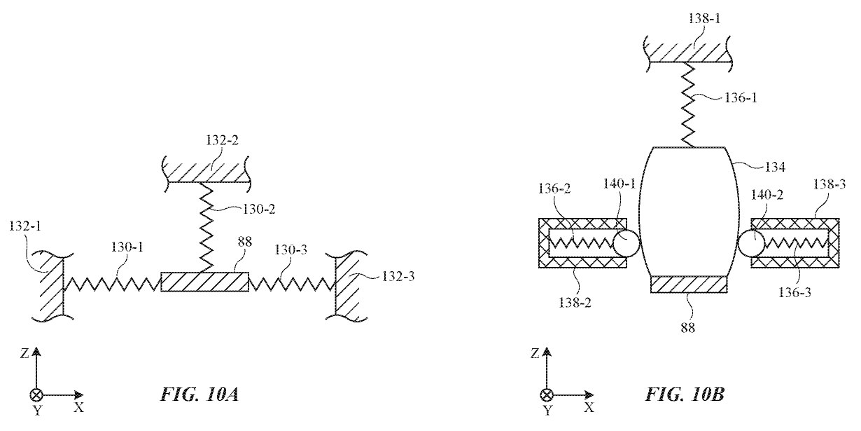

One additional example of an inverse stiffness component is bistable springs. FIG. 10A is a side view of an illustrative lens shaping element attached to bistable springs. As shown, the lens shaping element may be attached to a first spring 130-1, a second spring 130-2, and a third spring 130-3. Each spring may be attached between the lens shaping element and a respective anchor structure 132. Anchor structures 132-1, 132-2, and 132-3 may be attached to mechanical ground within the tunable lens and are therefore static. The three springs in FIG. 10A may be arranged such that the system is bistable (with two stable equilibrium positions). The bistable springs may cause an inverse stiffness at snap through.

The example in FIG. 10A of using springs to form the bistable system is merely illustrative. If desired, one or more of the springs may be replaced with another component such as a preloaded wire. Using a preloaded wire instead of a spring may enable a more compact actuator. In general, any of the springs described herein may optionally be replaced with a preloaded wire.

Another example of an inverse stiffness component is a cam roller mechanism. FIG. 10B is a side view of an illustrative lens shaping element attached to a cam roller mechanism. As shown, the lens shaping element may be attached to a first cam structure 134. The cam structure 134 may have first and second opposing sides with convex curvature. The cam structure is attached to an anchor structure 138-1 via spring 136-1. The cam structure 134 may be biased by bearings 140-1 and 140-2. Bearing 140-1 is constrained in the Z-direction by anchor structure 138-2. A spring 136-2 connected between bearing 140-1 and anchor structure 138-2 biases cam structure 134 in the positive X-direction. Bearing 140-2 is constrained in the Z-direction by anchor structure 138-3. A spring 136-3 connected between bearing 140-2 and anchor structure 138-3 biases cam structure 134 in the negative X-direction. Anchor structures 138-1, 138-2, and 138-3 may be attached to mechanical ground within the tunable lens and are therefore static. The cam roller mechanism of FIG. 10B may cause an inverse stiffness at snap through.

Bistable springs (preloaded wires) of the type shown and described herein may be used with a flexure pivot, a rolling pivot, and/or a sliding pivot if desired.

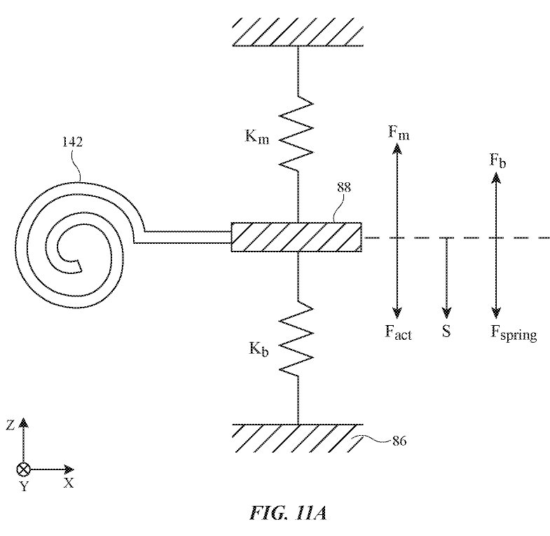

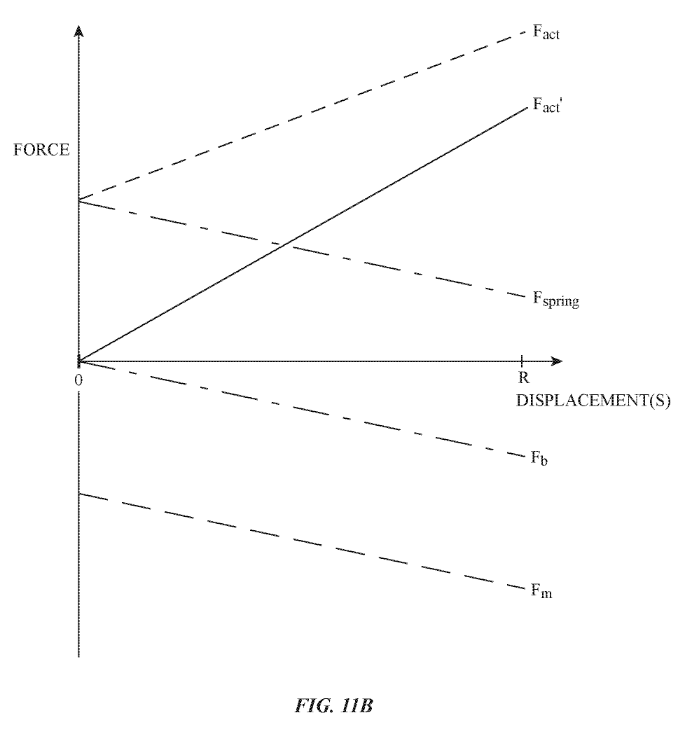

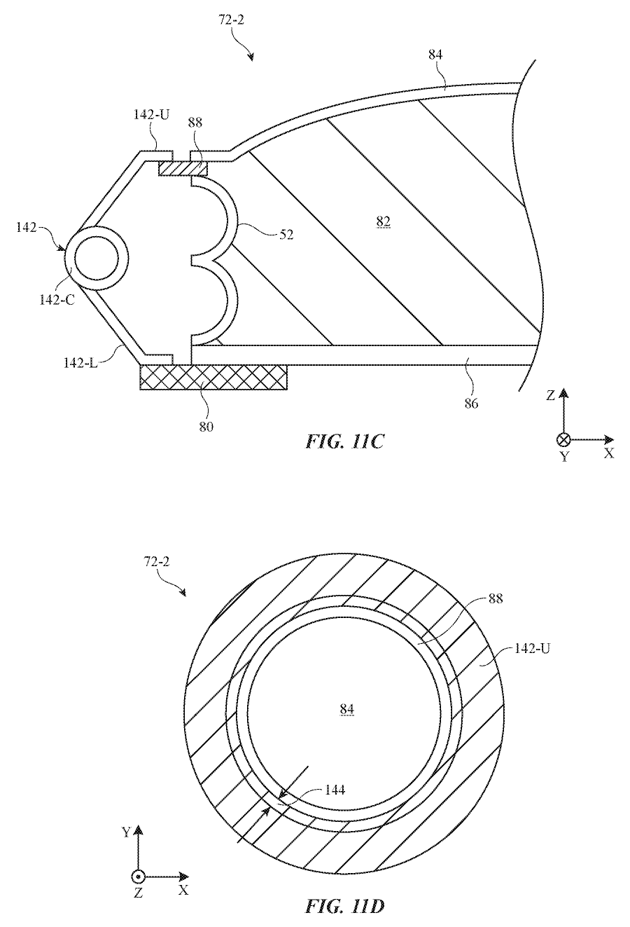

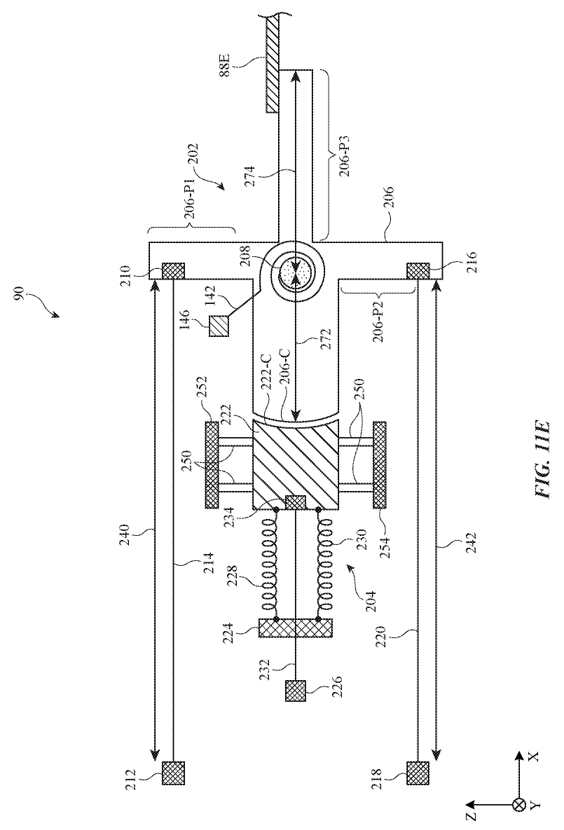

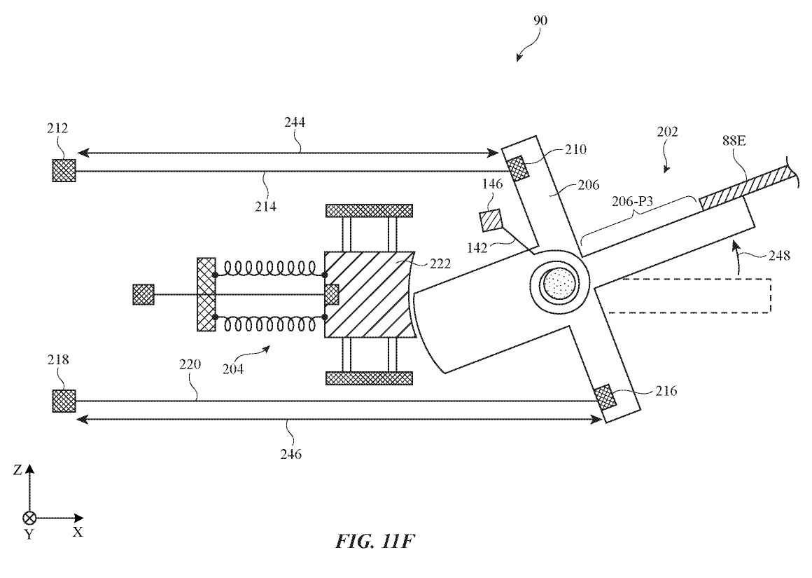

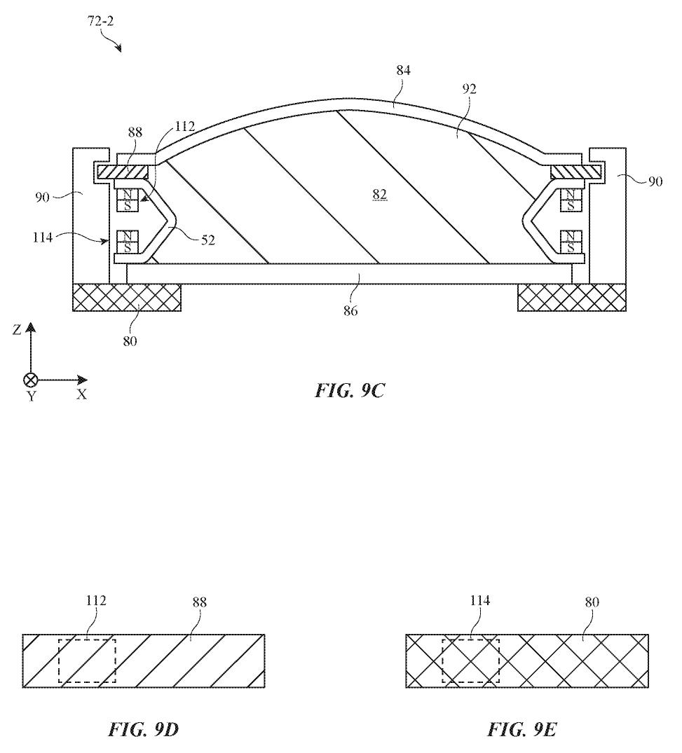

In another possible arrangement, shown in FIGS. 11A-11F, one or more springs may be used to mitigate total actuation energy for an actuator. FIG. 11A is a simplified force diagram of a tunable lens with one or more springs. In the example of FIG. 11A, a spring 142 is attached to lens shaping element 88. The spring may be a torsion spring such as a helical torsion spring that applies a force F_{spring} on lens shaping element 88 in the negative Z-direction.

FIG. 11B is a graph of force as a function of displacement (e.g., stroke S from FIG. 11A) across a displacement range from 0 to R. The forces Fₘ and F_{b} are the same in FIG. 11B as in FIG. 7B. However, there is an additional force F_{spring} that may lower the total actuation energy. As shown in FIG. 11B, the magnitude of force F_{spring} may decrease with increasing displacement. However, the magnitude of force F_{spring} is positive across the entire displacement range from 0 to R.

FIG. 11B shows a profile for actuation force F_{act}’ associated with a tunable lens with the spring(s) of FIG. 11A. The actuation force F_{act} from FIG. 7B is shown in FIG. 11B for comparison. As shown in FIG. 11B, actuation force F_{act}’ is less than F_{act} across the entire displacement range. The total actuation energy (associated with F_{act}’) is therefore lower in FIG. 11B than in FIG. 7B.

FIG. 11C is a cross-sectional side view of an illustrative tunable lens with a spring of the type shown in FIG. 11A. In the example of FIG. 11C, a helical torsion spring is attached to both lens shaping element 88 and chassis 80. In particular, the helical torsion spring 142 has a first portion 142-C (sometimes referred to as coil portion 142-C) with a plurality of coils. A second portion 142-U (sometimes referred to as upper portion 142-U) extends from the coil portion and is attached to an upper surface of lens shaping element 88. A third portion 142-L (sometimes referred to as lower portion 142-L) extends from the coil portion and is attached to an upper surface of chassis 80. The upper portion 142-U is biased towards the lower portion 142-L (e.g., in the negative Z-direction) by coil portion 142-C. Therefore, lens shaping element 88 is biased towards chassis 80 by spring 142.

FIG. 11D is a top view of the tunable lens of FIG. 11C. FIG. 11D shows how spring 142 may extend around the entire periphery of the tunable lens in order to evenly apply the bias force on lens shaping element 88 around the entire periphery of the tunable lens. The lens shaping element 88 and the torsion spring 142 have an overlap portion 144 that extends around the entire circumference of the lens shaping element.

In an alternate arrangement, a plurality of discrete torsion springs may be distributed around the periphery of the lens shaping element. However, this may cause local deformation in the lens shaping element that may not be desired in some designs.

If desired, a spring may be incorporated into actuator 90 that is used to manipulate the lens shaping element. FIG. 11E is a cross-sectional side view of an illustrative actuator 90 from FIG. 6. In the example of FIG. 11E, actuator 90 is a shape memory alloy (SMA) actuator. As shown in FIG. 11E, the actuator may include a pivot assembly 202 and a brake assembly 204. A spring 142 may be incorporated into the pivot assembly 202 to mitigate the total actuation energy of actuator 90.

Pivot assembly 202 includes a structure 206 (sometimes referred to as rotating structure 206, moveable structure 206, main structure 206, etc.) that is configured to rotate around pivot structure 208. Pivot structure 208 may include a pin or other desired structure. Structure 206 may have an opening that is aligned with and receives pivot structure 208. As shown in FIG. 11E, rotating structure 206 may include a first protruding portion 206-P1, a second protruding portion 206-P2, and a third protruding portion 206-P3. The item intended to be moved by actuator 90 may be attached to third protruding portion 206-P3. In this example, the item intended to be moved by actuator 90 is extension 88E but other components may be moved by actuator 90 if desired.

FIG. 11E shows how a portion of lens shaping element 88 such as extension 88E may be attached to third protruding portion 206-P3. Rotation of structure 206 around pivot structure 208 therefore causes displacement of extension 88E along the Z-direction.

A first SMA wire 214 may be connected between anchor structures 210 and 212. Anchor structures 210 and 212 (sometimes referred to as connector structures 210 and 212, mechanical connection structures 210 and 212, electrical connection structures 210 and 212, mechanical and electrical connection structures 210 and 212, etc.) may be both mechanically and electrically connected to SMA wire 214. Mechanically, anchor structure 212 may be attached to a fixed structure in tunable lens 72-2 such as chassis 80 or a housing for the actuator whereas anchor structure 210 may be attached to portion 206-P1 of structure 206. Anchor structures 210 and 212 may also provide electrical connections to SMA wire 214. Control circuitry 14 may control voltages applied to anchor structures 210 and 212 to control a current through SMA wire 214. The current through SMA wire 214 may be adjusted to selectively contract SMA wire 214. When a current is applied to SMA wire 124 to cause the SMA wire to contract, the contraction may apply a force to anchor structure 210 (and therefore portion 206-P1 of structure 206) in the negative X-direction.

The aforementioned example of the anchor structures being attached to other components (e.g., chassis 80, portion 206-P1, etc.) is merely illustrative. The anchor structures may be discrete structures that are attached to other device components. Alternatively, the anchor structures may be portions of the other device components. For example, a portion of chassis 80 and/or structure 206 may serve as mechanical anchor structures for SMA wire 214 (without an intervening discrete anchor structure). This is true for all of the anchor structures described herein.

A second SMA wire 220 may be connected between anchor structures 216 and 218. Anchor structures 216 and 218 (sometimes referred to as connector structures 216 and 218, mechanical connection structures 216 and 218, electrical connection structures 216 and 218, mechanical and electrical connection structures 216 and 218, etc.) may be both mechanically and electrically connected to SMA wire 220. Mechanically, anchor structure 218 may be attached to a fixed structure in tunable lens 72-2 such as chassis 80 or a housing for the actuator whereas anchor structure 216 may be attached to portion 206-P2 of structure 206. Anchor structures 216 and 218 may also provide electrical connections to SMA wire 220. Control circuitry 14 may control voltages applied to anchor structures 216 and 218 to control a current through SMA wire 220. The current through SMA wire 220 may be adjusted to selectively contract SMA wire 220. When a current is applied to SMA wire 220 to cause the SMA wire to contract, the contraction may apply a force to anchor structure 216 (and therefore portion 206-P2 of structure 206) in the negative X-direction.

Control circuitry 14 may therefore control the contraction of SMA wires 214 and 220, which selectively rotates structure 206 around pivot structure 208, which selectively moves extension 88E along the Z-direction.

Actuator 90 may include brake assembly 204 in addition to pivot assembly 202. Brake assembly 204 may be configured to selectively apply a bias force to rotating structure 206 to hold the rotating structure 206 in a fixed position. The brake may fix the position of rotating structure 206 when actuator 90 is not receiving power. Including the brake may therefore reduce the power consumption required to operate actuator 90.

As shown in FIG. 11E, brake assembly 204 may include a brake structure 222. One or more bias structures such as springs may be coupled between brake structure 222 and anchor 224. In FIG. 11E, springs 228 and 230 are coupled between brake structure 222 and anchor 224. Anchor structure 224 may be attached to a fixed structure in tunable lens 72-2 such as chassis 80 or a housing for the actuator. Springs 228 and 230 may bias brake structure 222 in the positive X-direction towards structure 206. In the absence of a force from SMA wire 232, brake structure 222 presses into structure 206 to fix the position of structure 206. As shown in FIG. 11E, brake structure 222 may have a concave surface 222-C that mates with a corresponding convex surface 206-C of structure 206.

A third SMA wire 232 may be connected between anchor structures 226 and 234. Anchor structures 226 and 234 (sometimes referred to as connector structures 226 and 234, mechanical connection structures 226 and 234, electrical connection structures 226 and 234, mechanical and electrical connection structures 226 and 234, etc.) may be both mechanically and electrically connected to SMA wire 232. Mechanically, anchor structure 226 may be attached to a fixed structure in tunable lens 72-2 such as chassis 80 or a housing for the actuator whereas anchor structure 234 may be attached to brake structure 222. Anchor structures 226 and 234 may also provide electrical connections to SMA wire 232. Control circuitry 14 may control voltages applied to anchor structures 226 and 234 to control a current through SMA wire 232. The current through SMA wire 232 may be adjusted to selectively contract SMA wire 232. When a current is applied to SMA wire 232 to cause the SMA wire to contract, the contraction may apply a force to anchor structure 234 (and therefore brake structure 222) in the negative X-direction.

When SMA wire 232 pulls brake structure 222 with sufficient force to overcome the bias force provided by bias structures 228/230, brake structure 222 moves in the negative X-direction. This may be referred to as releasing the brake. While the brake is released, structure 206 may rotate freely around pivot structure 208. It is noted that the brake does not need to be fully disengaged to enable movement of structure 206. The frictional force between the brake structure 222 and structure 206 just needs to be less than the drive force to allow movement of structure 206. SMA wires 214/220 may be used to rotate structure 206 while the brake is released. Once structure 206 is in a desired position, the brake may be engaged by relaxing SMA wire 232 such that brake structure 222 is again biased into structure 206. The position of structure 206 is thereafter fixed while the brake is engaged.

FIGS. 11E and 11F show an example of structure 206 being rotated to move extension 88E in the positive Z-direction. In FIG. 11E, SMA wire 214 has a first length 240 and SMA wire 220 has a second length 242. In FIG. 11F, SMA wire 214 has been contracted and the length of SMA wire 214 has been reduced to a third length 244 that is less than first length 240 from FIG. 11E. Meanwhile SMA wire 220 has been relaxed and the length of SMA wire 220 in FIG. 11F has been increased to a fourth length 246 that is greater than second length 242 from FIG. 11E. As shown in FIG. 11F, this change in the forces applied by SMA wires 214 and 220 causes structure 206 (including protruding portion 206-P3 and therefore extension 88E) to rotate in counterclockwise direction 248. Rotating structure 206 counterclockwise in this manner moves extension 88E in the positive Z-direction. In the opposite arrangement (e.g., when length 244 increases and length 246 decreases), structure 206 may rotate clockwise which moves extension 88E in the negative Z-direction.

As shown in FIG. 11E, structure 206 may have a length 272 between the center of pivot structure 208 and convex surface 206-C and a length 274 between the center of pivot structure 208 and the end of protruding portion 206-3. The friction force at the interface of surfaces 222-C and 206-C may be proportional to the ratio of the gearing between extension 88E and frictional translation. To lower the normal force required on the friction surface, the ratio of the length 272 to length 274 may be increased. Lowering the normal force using a relatively high ratio of length 272 to length 274 may allow for a smaller and more compact bias structure(s) 228/230, lower stresses within the system, and a lower required force for SMA wire 232 that releases the braking structure. The ratio of length 272 to length 274 may be at least 0.25, at least 0.3, at least 0.4, at least 0.5, at least 0.75, at least 1, at least 1.5, at least 2, at least 3, etc.

To improve the performance of actuator 90, it may be desirable to include one or more components that limit undesired shifting of brake structure 222 along the Z-direction. If brake structure 222 shifts along the Z-direction, there may be backlash that prevents extension 88E from being moved in a desired manner.

To mitigate motion of brake structure 222 in the Z-direction, brake structure 222 may be attached to one or more guide structures 250. First and second guide structures 250 may be attached between anchor structure 252 and brake structure 222 on the positive Z-side of brake structure 222. Third and fourth guide structures 250 may be attached between anchor structure 254 and brake structure 222 on the negative Z-side of brake structure 222.

Anchor structures 252 and 254 may be attached to a fixed structure in tunable lens 72-2 such as chassis 80 or a housing for the actuator. Each one of guide structures 250 may have a high stiffness in the Z-direction and the Y-direction but a low stiffness in the X-direction. The guide structures may therefore limit undesired motion of brake structure 222 along the Z-axis while allowing the desired motion of brake structure 222 along the X-axis. Guide structures 250 in FIG. 11E may be referred to as flexures. The flexures may be formed from any desired material (e.g., plastic, a metal such as aluminum, etc.). The flexures may have a first dimension in the Z-direction, a second dimension in the Y-direction, and a third dimension in the X-direction. The third dimension may be smaller than the first and/or second dimensions. The first dimension may be at least 2x greater than the third dimension, at least 4x greater than the third dimension, at least 8x greater than the third dimension, at least 16x greater than the third dimension, etc. The second dimension may be at least 2x greater than the third dimension, at least 4x greater than the third dimension, at least 8x greater than the third dimension, at least 16x greater than the third dimension, etc.

To mitigate the total actuation energy required by SMA actuator 90, a torsion spring may be incorporated into pivot assembly 202. As shown in FIG. 11E, the torsion spring 142 may be attached between anchor structure 146 and rotating structure 206. The torsion spring may also be wrapped around pivot structure 208. Torsion spring 142 may cause a bias force to be applied to tab 88E. The bias force may be applied to the lens shaping element in the negative Z-direction when the tunable lens is designed for the lens shaping element to be displaced in the negative Z-direction (as in FIGS. 11A and 11B) and may be applied to the lens shaping element in the positive Z-direction when the tunable lens is designed for the lens shaping element to be displaced in the positive Z-direction.

A single tunable lens may comprise bellows structures that are in tension for some or all of the displacement range of the lens shaping element (e.g., sheet bellows, C-shaped bellows, W-shaped bellows), a pre-deformed lens shaping element, a magnetic negative stiffness element, a bistable springs negative stiffness mechanism, a cam roller negative stiffness mechanism, and/or a torsion spring.

The foregoing is merely illustrative and various modifications can be made to the described embodiments. The foregoing embodiments may be implemented individually or in any combination.

What is claimed is:

1. A tunable lens comprising:
a lens element having a periphery;
a lens shaping element attached to the periphery of the lens element;
actuators distributed around the periphery, wherein each actuator is configured to adjust a position of the lens shaping element in a first direction within a displacement range; and
a structure that is attached to the lens shaping element and that extends in the first direction away from the lens shaping element, wherein the structure is in tension when the lens shaping element is within at least some of the displacement range.

2. The tunable lens defined in claim 1, wherein the structure is in tension when the lens shaping element is within the entire displacement range.

3. The tunable lens defined in claim 1, further comprising:
an additional lens element, wherein the structure is attached between the lens shaping element and the additional lens element.

4. The tunable lens defined in claim 3, further comprising a fluid that fills a chamber, wherein the lens element, the additional lens element, and the structure define walls for the chamber.

5. The tunable lens defined in claim 3, further comprising:
a chassis, wherein the actuators and the additional lens element are attached to the chassis.

6. The tunable lens defined in claim 5, further comprising:
a first magnetic structure that is connected to the lens shaping element; and
a second magnetic structure that is connected to the chassis, wherein the first and second magnetic structures are attracted to one another along the first direction.

7. The tunable lens defined in claim 1, further comprising:
bistable springs that are attached to the lens shaping element.

8. The tunable lens defined in claim 1, further comprising:
a cam roller mechanism that is attached to the lens shaping element.

9. The tunable lens defined in claim 1, further comprising:
a torsion spring that is attached to the lens shaping element.

10. The tunable lens defined in claim 9, wherein the torsion spring extends around the entire periphery.

11. The tunable lens defined in claim 1, wherein each actuator comprises a torsion spring that is configured to bias the lens shaping element in the first direction.

12. A tunable lens comprising:
a first lens element having a periphery;
a lens shaping element attached to the periphery of the first lens element;
a second lens element;
fluid interposed between the first and second lens elements;
actuators distributed around the periphery, wherein each actuator is configured to adjust a position of the lens shaping element in a first direction towards the second lens element;
a first magnetic structure that is attached to the lens shaping element, wherein the first magnetic structure moves in parallel with the lens shaping element; and
a second magnetic structure that is attracted to the first magnetic structure, wherein the second magnetic structure is adjacent to the second lens element.

13. The tunable lens defined in claim 12, wherein the first and second magnetic structures comprise first and second permanent magnets.

14. The tunable lens defined in claim 12, wherein one of the first and second magnetic structures comprises a permanent magnet and wherein a remaining of the first and second magnetic structures comprises a piece of material having a relative magnetic permeability of at least 15.

15. The tunable lens defined in claim 12, wherein the first magnetic structure is embedded within the lens shaping element.

16. The tunable lens defined in claim 12, further comprising:
a bellows structure that is attached between the first and second lens elements; and
a chassis that is attached to the second lens element.

17. The tunable lens defined in claim 16, wherein the second magnetic structure is embedded within the chassis.

18. The tunable lens defined in claim 16, wherein the second magnetic structure is attached directly to the bellows structure, the second lens element, or the chassis.

19. A tunable lens comprising:
a lens element having a periphery;
a lens shaping element attached to the periphery of the lens element;
actuators distributed around the periphery, wherein each actuator is configured to adjust a position of the lens shaping element in a first direction within a displacement range;
a bellows structure that is attached to the lens shaping element, wherein the bellows structure is in tension when the lens shaping element is within at least some of the displacement range; and
a fluid-filled chamber with walls that include at least the bellows structure and the lens element.

20. The tunable lens defined in claim 19, wherein the bellows structure comprises a structure selected from the group consisting of: a C-shaped structure and a W-shaped structure.

21. The tunable lens defined in claim 19, wherein the lens shaping element is pre-deformed to reduce peak forces needed by the actuators.
